(19) United States
(12) Patent Application Publication
(10) Pub. No.: US 2008/0091754 A1
(43) Pub. Date: Apr. 17, 2008

(54) RECIPROCAL CALCULATION UNIT AND RECIPROCAL CALCULATION METHOD

(75) Inventor: Hiroki Hasebe, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 11/869,353

(22) Filed: Oct. 9, 2007

(30) Foreign Application Priority Data
Oct. 10, 2006 (JP) 2006-276490

(51) Int. Cl. G06F 1/02; G06F 5/01

(52) U.S. Cl. 708/209; 708/274

(57) ABSTRACT

A reciprocal calculation unit comprising: a data transformation portion that, through a first bit shift operation, transforms the input data to intermediate data that falls in a predetermined data extent; a range identification portion that identifies a range to which the intermediate data belongs out of ranges that are established within the data extent and have boundary values defined by values of factorials of 2; a reciprocal calculation portion that calculates a coefficient of a linear approximation formula of an inverse proportional curve with the intermediate data as variables based on one boundary value and another boundary value of the range to which the intermediate data belongs, and calculates a reciprocal of the intermediate value from the calculated coefficient and the intermediate data; and a data re-transformation portion that, through a second bit shift operation, transforms the reciprocal of the intermediate data to a reciprocal of the input data.

### BACKGROUND OF THE INVENTION

1. Field of the Invention

The present invention relates to a reciprocal calculation unit and reciprocal calculation method that calculate a reciprocal of input data.

Priority is claimed on Japanese Patent Application No, 2006-276490, filed on Oct. 10, 2006, the contents of which are incorporated herein by reference.

2. Description of Related Art

In embedded systems, the following methods are generally known as methods for acquiring a reciprocal (x⁻¹) of input data (x) faster than those by repeated operation. The first method has the values of the reciprocals for input data previously stored in the memory, and refers to the memory using the input data as an address to output the data of the reciprocal stored in the memory. The second method has the gradient data and intercept data of linear formulas of lines that approximate the inverse proportional curve (x⁻¹) previously stored in the memory, derives an approximation formula of the inverse proportional curve by using the gradient data value and intercept data value according to the input data and taken out of the memory, and uses the approximation formula to calculate the reciprocal of the input data. However, these methods have a problem in that if the data widths of the input data as well as the data stored in the memory become wider, the memory becomes larger.

To address this problem, Japanese Unexamined Patent Application, First Publication No. 2000-81968 proposes the following method for calculating a reciprocal of input data x. As shown in the following formula, the reciprocal y of x is obtained as a result of a data transformation in which input data x is transformed to data x′ in a specific data extent through a bit shift, the second method described above is applied to the data x′ to calculate a reciprocal y′ of x′, and y′ is subjected to a bit shift.

$$\frac{1}{x} = ( \frac{{2}^{- n}}{{2}^{- n} x} ) = {2}^{- n} ( \frac{1}{{x}^{′}} ) = {2}^{- n} {y}^{′} = y ( n : Integer )$$

This method has no effect on the data extent of x′ even if the data width of x becomes wider. As a result, as for the gradient data value and intercept data value of linear formulas that approximate the inverse proportional curve, it will suffice that only the data extent of x′ is stored in the memory. Therefore, the reciprocal calculation unit according to Japanese Unexamined Patent Application, First Publication No. 2000-81968 can perform a fast calculation of reciprocals without the need for a large-scale memory.

### SUMMARY OF THE INVENTION

The present invention is a reciprocal calculation unit including: a data transformation portion that, through a first bit shift operation on input data, transforms the input data to intermediate data that falls in a predetermined data extent; a range identification portion that identifies a range to which the intermediate data belongs out of ranges that are established within the data extent and have boundary values defined by values of factorials of 2; a reciprocal calculation portion that calculates a coefficient of a linear approximation formula of an inverse proportional curve with the intermediate data as variables based on one boundary value and another boundary value of the range to which the intermediate data belongs, and calculates a reciprocal of the intermediate value from the calculated coefficient and the intermediate data; and a data re-transformation portion that, through a second bit shift operation corresponding to the first bit shift operation, transforms the reciprocal of the intermediate data to a reciprocal of the input data.

Furthermore, in the reciprocal calculation unit of the present invention, it is preferable that the reciprocal calculation portion calculate the coefficient assuming that the linear approximation formula is a line that passes through points on the inverse proportional curve that respectively correspond to the one boundary value and the another boundary value.

Furthermore, in the reciprocal calculation unit of the present invention, it is preferable that the reciprocal calculation portion calculate the coefficient assuming that the linear approximation formula is formed by linking tangent lines at points on the inverse proportional curve that respectively correspond to the one boundary value and the another boundary value.

Furthermore, in the reciprocal calculation unit of the present invention, it is preferable that the reciprocal calculation portion calculate the coefficient by averaging a first coefficient assuming that the linear approximation formula is a line that passes through points on the inverse proportional curve that respectively correspond to the one boundary value and the another boundary value and a second coefficient assuming that the linear approximation formula is formed by linking tangent lines at points on the inverse proportional curve that respectively correspond to the one boundary value and the another boundary value.

Furthermore, the present invention is a reciprocal calculation method that performs the steps including: a data transformation step that, through a first bit shift operation on input data, transforms the input data to intermediate data that falls in a predetermined data extent; a range identification step that identifies a range to which the intermediate data belongs out of ranges that are established within the data extent and have boundary values defined by values of factorials of 2; a reciprocal calculation step that calculates a coefficient of a linear approximation formula of an inverse proportional curve with the intermediate data as variables based on one boundary value and another boundary value of the range to which the intermediate data belongs, and calculates a reciprocal of the intermediate value from the calculated coefficient and the intermediate data; and a data re-transformation step that, through a second bit shift operation corresponding to the first bit shift operation, transforms the reciprocal of the intermediate data to a reciprocal of the input data.

Furthermore, in the reciprocal calculation method of the present invention, it is preferable that the reciprocal calculation step calculate the coefficient assuming that the linear approximation formula is a line that passes through points on the inverse proportional curve that respectively correspond to the one boundary value and the another boundary value.

Furthermore, in the reciprocal calculation method of the present invention, it is preferable that the reciprocal calculation step calculate the coefficient assuming that the linear approximation formula is formed by linking tangent lines at points on the inverse proportional curve that respectively correspond to the one boundary value and the another boundary value.

Furthermore, in the reciprocal calculation method of the present invention, it is preferable that the reciprocal calculation step calculate the coefficient by averaging a first coefficient assuming that the linear approximation formula is a line that passes through points on the inverse proportional curve that respectively correspond to the one boundary value and the another boundary value and a second coefficient assuming that the linear approximation formula is formed by linking tangent lines at points on the inverse proportional curve that respectively correspond to the one boundary value and the another boundary value.

### BRIEF DESCRIPTION OF THE DRAWINGS

FIG. 1 is a block diagram showing a configuration of a reciprocal calculation unit according to a first embodiment of the present invention.

FIG. 2 is a flowchart showing an operational procedure of the reciprocal calculation unit according to the first embodiment of the present invention.

FIG. 3A is a reference diagram showing a relationship between intermediate data and ranges in the first embodiment of the present invention.

FIG. 3B is another reference diagram showing a relationship between intermediate data and ranges in the first embodiment of the present invention.

FIG. 4 is a graph showing an approximation formula of an inverse proportional curve in the first embodiment of the present invention.

FIG. 5 is a graph showing an approximation formula of an inverse proportional curve in a second embodiment of the present invention.

FIG. 6 is another graph showing an approximation formula of the inverse proportional curve in the second embodiment of the present invention.

### DETAILED DESCRIPTION OF THE INVENTION

Hereunder is a description of the embodiments of the present invention with reference to the drawings.

### First Embodiment

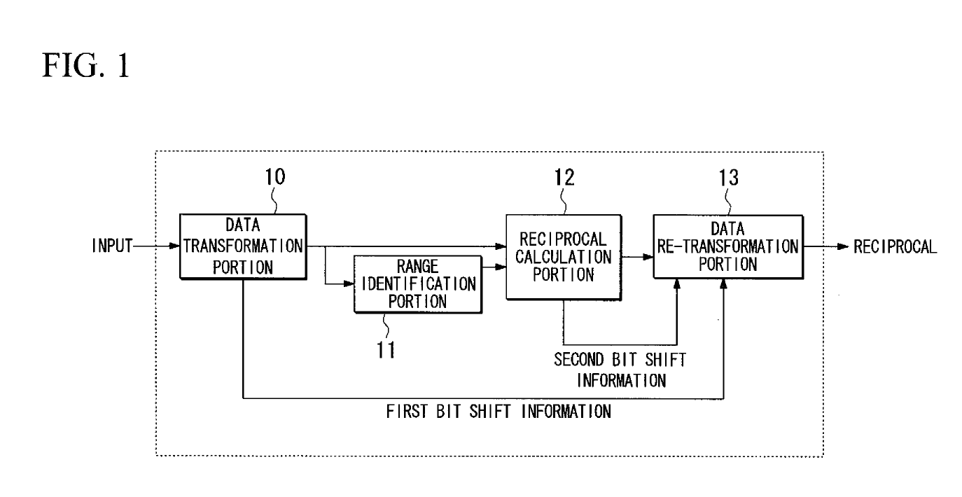

First, a first embodiment of the present invention will be described. FIG. 1 shows a configuration of a reciprocal calculation unit according to the present embodiment. A data transformation portion 10 transforms input data x to intermediate data (x′ or x″, which will be described later) that falls in a predetermined data extent through a bit shift operation on the input data x. The data transformation processing by the data transformation portion 10 corresponds to the processing that transforms input data x to data x′ in a specific data extent through a bit shift, as disclosed in Japanese Unexamined Patent Application, First Publication No. 2000-81968.

A range identification portion 11 determines a range to which the intermediate data belongs out of ranges that are included in a predetermined data extent and have boundary values defined by values of factorials of 2. The predetermined data extent of the present embodiment is an extent whose boundary values are 2⁰ and 2ⁿ (n is an integer equal to or more than 1). Sub-extents formed by segmenting this data extent at values of factorials of 2 are the ranges of the present embodiment. The data extent may be divided into a plurality of ranges, and may coincide with the range depending on the way the data extent is established.

A reciprocal calculation portion 12 derives an approximation formula that approximates the inverse proportional curve (the curve that represents reciprocals) in the range to which the intermediate data belongs through any one of the addition, subtraction, and bit shift operations on the boundary values of the range, thereby calculating a reciprocal of the intermediate data from the intermediate data and the approximation formula. As is described later, by taking a formula of a line that passes through the boundary values of the range to which the intermediate data belongs as an approximation formula of the inverse proportional curve, the present embodiment is capable of deriving the approximation formula only with an adder (a subtracter) and a bit shift.

A data re-transformation portion 13 transforms the reciprocal of the intermediate data acquired by the reciprocal calculation portion 12 to a reciprocal of the input data x through a bit shift operation that corresponds to the bit shift operation performed by the data transformation portion 10.

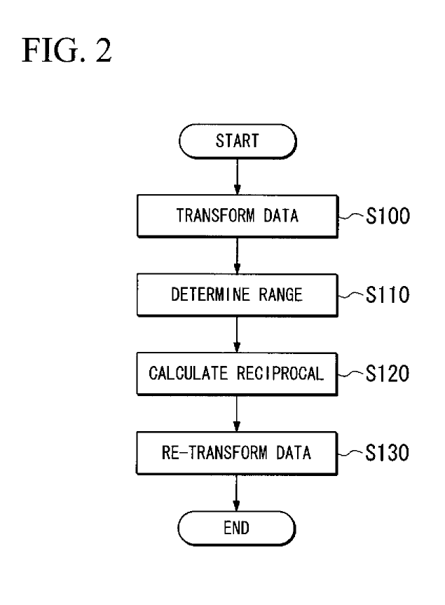

Next is a description of a reciprocal calculation method according to the present embodiment. Hereinafter, the description is made on the assumption that the data to be inputted to the reciprocal calculation unit is non-zero. FIG. 2 shows an operational procedure of the reciprocal calculation unit. Reference is appropriately made to FIG. 2.

The data transformation portion 10 transforms input data x to intermediate data x′ or x″ that falls in the data extent with boundary values defined by values of factorials of 2 through a bit shift operation on the input data x (step S100 of FIG. 2). The intermediate data x′ is used for convenience in description of the concept of the present embodiment. The intermediate data x″ is data that corresponds to the data type actually used inside the reciprocal calculation unit.

When input data x is transformed to intermediate data x′ included in the extent of 2⁰≦×<2ⁿ, it is determined whether bits are non-zero in groups of n bits from the MSB (Most Significant Bit) side. For example, letting the input data x be 0x053C, a 16-bit integer, and n be 4, it is determined whether the bits constituting the input data x are non-zero in groups of 4 bits. Subsequently, among the combinations of n bits of the input data x, the first combination of n bits in which non-zero is detected is assumed to be the (s+1)th (s=0, 1, 2, 3 . . . ) combination of n bits. For example, in the case where the input data x is 0x053C and n is 4, the 2nd combination of 4 bits is 5 and hence non-zero. Therefore, s is 1.

Next, a bit shift operation is performed on the input data x to the right by (m−n(1+s)) bits so that the non-zero combination of n bits will be the integral part of the intermediate data x′. To prevent the loss of valid data through this bit shift operation, it is necessary to perform bit expansion before the bit shift operation. For example, if the input data x is an m-bit integer, it is expanded to a 2m-bit data which is composed of an m-bit integral part and an m-bit decimal part. Therefore, in the aforementioned example, the intermediate data x′ is derived as follows:
x′=0x00053C00(16-bit integral part, 16-bit decimal part)

Subsequently, this intermediate data x′ is subjected to a bit shift operation for adjustment to a data format in the later stages, and is output as intermediate data x″ to the range identification portion 11 and the reciprocal calculation portion 12. For example, when it is adjusted to a data format of intermediate data x″ which is an m-bit data composed of an n-bit integral part and an (m-n)-bit decimal part, the intermediate data x′ is bit-shifted to the left by (m-n) bits and the m bits on the MSB side are outputted as intermediate data x″ to the later stages. Therefore, in the aforementioned example, because m=16 and n=4, the intermediate data x′ is bit-shifted to the left by 12 bits, and the 16 bits on the MSB side are outputted as intermediate data x′″ to the later stages (x″=0x53c0).

From above, the relationship between the intermediate data x′ and the intermediate data x″ is expressed as follows:
x″2^{(m-n)}x′,

Furthermore, the relationship between the input data x and the intermediate data x″ is expressed as follows:
x″=2^{sn}x

To simplify these bit shift operations and bit expansion, it is preferable to perform a left bit shift operation by sn bits, a single operation into which two operations of the above-mentioned right bit shift operation by (m−n(1+s)) bits and left bit shift operation by (m−n) bits are integrated. Moreover, for a bit shift operation by the data re-transformation portion 13, s is outputted to the data re-transformation portion 13 as first bit shift information that indicates how many bits are shifted in the data transformation portion 10. For example, if the input data x is 0x053C, the intermediate data x″ is 0x53C0 and the first bit shift information s is 1.

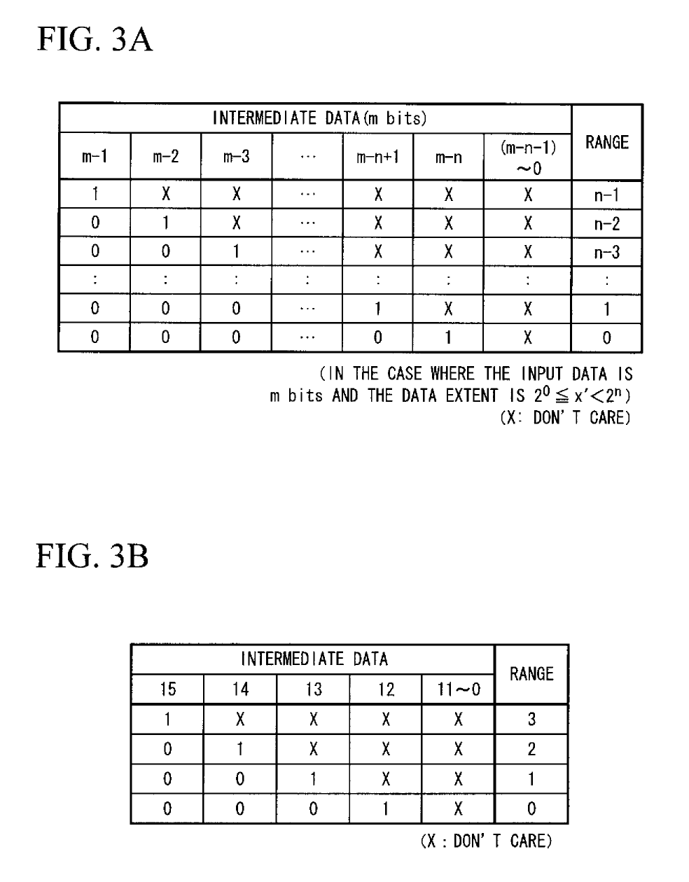

The range identification portion 11 determines the range to which the intermediate data x′ belongs (step S110 of FIG. 2). Ranges arc segmented portions of the data extent of 2⁰≦x′<2′ to which x′ is included, the portions being segmented at every value of factorials of 2. The range to which x′ belongs can be specified by sequentially determining from the MSB side whether each bit of the intermediate data x″ is 1. FIG. 3A shows the relationship between the values of the individual bits of the intermediate data x″ (assuming that the most significant bit is the m−1th bit and the least significant bit is the 0th bit) and the ranges to which the intermediate data x′ belongs.

For example, when the data extent of 2⁰≦x′<2⁴ to which x′ is included is segmented at every value of factorials of 2, the data extent is segmented into four ranges: a range 0 of 2⁰≦x≦2¹, a range 1 of 2¹≦x′<2², a range 2 of 2²≦x′<2³, and a range 3 of 2³≦x′<2⁴. If the intermediate data x″ is 0x53 C0, FIG. 3B helps to determine that the intermediate data x′ belongs to the range 2 among these ranges 0 through 3.

The range information indicative of the range as specified above is outputted to the reciprocal calculation portion 12.

The reciprocal calculation portion 12 derives, in the range to which the intermediate data x′ belongs, a linear formula that approximates the inverse proportional curve representative of the reciprocal of x′ through an addition or subtraction and bit shift operations to calculate the reciprocal of x′ (step S120 of FIG. 2). Hereunder is a description of a method of deriving a linear formula that approximates the inverse proportional curve. The relationship between the intermediate data x′ and the reciprocal y′ of x′ is expressed by the following formula.
y′=x′⁻¹

At this time, the equation of a line that passes through the two points on the curve of y′, that is, the point (xₐ, xₐ⁻¹) and the point (x_{b}, x_{b}⁻¹) is expressed by the following formula.
y₀′={−x′+(xₐ+x_{b})}(xₐx_{b})⁻¹

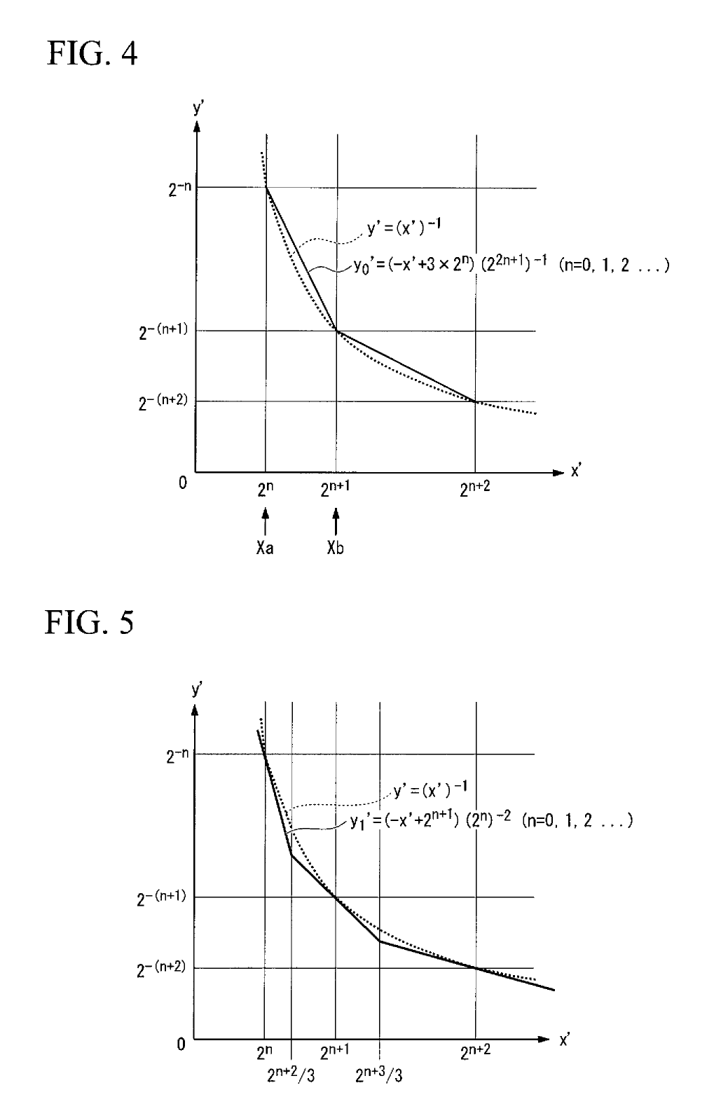

If xₐ and x_{b} are values of factorials of 2, y₀′ is derived only with an adder (a subtracter) and a bit shift register. That is, as shown in FIG. 4, if xₐ=2ⁿ and x_{b}=2ⁿ⁺¹ (n=0, 1, 2, 3, . . . ), y₀′ is expressed by the following formula.
y₀′=(−x′+3×2ⁿ)(2²ⁿ⁺¹)⁻¹

On the other hand, the range identification portion 11 needs to divide the ranges so that the reciprocal calculation portion 12 can derive y₀′ only with an adder (a subtracter) and a bit shift register. When the reciprocal calculation portion 12 derives y₀′, the range identification portion 11 needs to segment the ranges at every 2ⁿ, as shown in FIG. 4. As described above, if x′ is specified to belong to which range among the ranges segmented by values of factorials of 2, a linear formula that approximates y′ (for example, the above y₀′) can be derived only with an adder (a subtracter) and a bit shift register.

For example, if 2²≦x′<2³, then xₐ=2² and x_{b}=2³. Therefore, y₀′ is expressed by the following formula, where >> represents a right bit shift operation. Thus, the following formula shows that a right bit shift operation by 5 bits on the calculation result of (−x′+12) yields y₀′.
y₀′={−x′+(xₐ+x_{b})}(xₐx_{b})⁻¹={−x′+(2²+2³)}2²2³)⁻¹=(−x′+12)>>5

The reciprocal calculation portion 12 derives an approximation formula of the inverse proportional curve as described above based on the range information inputted from the range identification portion 11; calculates a reciprocal y″ of the intermediate data x″ from the approximation formula and the intermediate data x″ inputted from the data transformation portion 10; separates the calculation result into a provisional reciprocal data y′″ and second bit shift information t; and outputs them to the data re-transformation portion 13. Note that the bit width of the decimal portion of the provisional reciprocal data y′″ is matched with the bit width of the intermediate data x″.

For example, if the intermediate data x″ is 0x53C0 and the data extent of the intermediate data x′ is 2⁰≦x′<2⁴, then x′ belongs to the range 2 (refer to FIG. 3B). The approximation formula y₀′ of the inverse proportional curve y′ in this range 2 is derived as follows:
y₀′={−x′+(2²+2³)}(2²2³)⁻¹=(12−x′)>>5

When x″ is substituted into this formula, the reciprocal y″ of the intermediate data x″ is calculated.
y″=(0C_{HEX}−x′)>>⁵=(0C_{HEX}2¹²−x′2¹²)2¹²2⁻⁵=(0C000_{HEX}−053C0_{HEX})2⁻¹⁷=06C40_{HEX}>>17

Note that in the above formula, the following is taken into consideration.
x″=2^{(m-n)}x′=2⁽¹⁶⁻⁴⁾x′=2¹²x′

Here, if the bit width of the decimal portion of the provisional reciprocal y′″ is matched with the bit width of the intermediate data x″, the reciprocal y″ of the intermediate data x″ is expressed by the following formula.
y″=06C40_{HEX}>>5

From this y″, the provisional reciprocal data y′″ (=0x06C40) and the second bit shift information t (=5) are outputted to the data re-transformation portion 13.

The data re-transformation portion 13 performs a bit shift operation on the provisional reciprocal data y′″ inputted from the reciprocal calculation portion 12 based on the first bit shift information s inputted from the data transformation portion 10 and the second bit shift information t inputted from the reciprocal calculation portion 12, thereby transforming the provisional reciprocal data y′″ to the reciprocal x⁻¹ of the input data x (step S130 of FIG. 2). In the reciprocal calculation method according to the present embodiment, the data transformation portion 10 has performed a bit shift operation on x (x>>k). Therefore, as shown in the following formula, the data re-transformation portion 13 needs to perform a bit shift operation on (x>>k)⁻¹. That is, the data re-transformation portion 13 performs a bit shift operation to the right by (m−n(1+s)) bits on the provisional reciprocal data y′″ in the case where the bit width of the input data x is m and the data extent of the intermediate data x′ is 2⁰≦x′<2ⁿ).

$$\frac{1}{x} = ( \frac{1}{{2}^{- k} x} ) {2}^{- k} = ( \frac{1}{x >> k} ) >> k ( k : Integer )$$

Therefore, the data retransformation portion 13 performs a bit shift operation, corresponds to the bit shift operation performed by the data transformation portion 10, on the provisional reciprocal data y′″ inputted from the reciprocal calculation portion 12, and additionally performs a bit shift operation that has not been performed in the reciprocal calculation portion 12. The data re-transformation portion 13 then outputs, as the reciprocal y of the input data x, the result of performing the bit shift operations on the provisional reciprocal data y′″. Note that the bit width of y is set to any bit width as required.

For example, if the first bit shift information s is 1, the provisional reciprocal data y′″ is 0x06C40, and the second bit shift information t is 5, then the reciprocal y is calculated as the following. In the following formula, as for figures representative of a bit shift amount, 8 is a bit shift amount acquired from the relationship between x and x′, 5 is a bit shift amount for the bit shift operation that has not been performed in the reciprocal calculation portion 12, and 12 is a bit shift amount acquired from the relationship between x′ and x″.
y=06C40_{HEX}>>(8+5+12)=0000000110110001000000_{BIN}(1 bit of the integral portion and 21 bits of the decimal portion)

As described above, according to the present embodiment, an approximation formula that approximates an inverse proportional curve indicative of a reciprocal x⁻¹ of input data x is derived through at least any one of the addition, subtraction, and bit shift operations. Therefore, a reciprocal of input data can be speedily calculated without the use of a memory that stores the gradient data values and intercept data values of the approximation formulas of the inverse proportional curve.

### Second Embodiment

Next is a description of a second embodiment of the present invention. In the first embodiment, when the reciprocal calculation portion 12 derives a linear formula that approximates y′=x′⁻¹, a line y₀′ that passes through two points on the curve of y′ is derived through at least any one of the addition, subtraction, and bit shift operations. In the present embodiment, an approximation formula y₁′ different from y₀′ is derived as the linear formula that approximates y′, and yₒ′ and y₁′ are combined, thereby allowing for calculation of the value of a reciprocal with higher accuracy than that of the first embodiment.

The linear formula y₁′ of the line that contacts the curve of y′=x′⁻¹ at the point (x_{c}, x_{c}⁻¹) of the curve is expressed by the following formula.
y₁′=(−x′+2x_{c})(x_{c})⁻²

Here, if x_{c} is a value of a factorial of 2, the derivation of the above formula is expressed only with an adder (a subtracter) and a bit shift register, as is the case with y₀′. For example, if x_{c}=2³, then y₁′ is expressed by the following formula
y₁′=(−x′+2x_{c})(x_{c})⁻²=(−x′+2×2²)(2²)⁻²=(−x′+2³)>>4

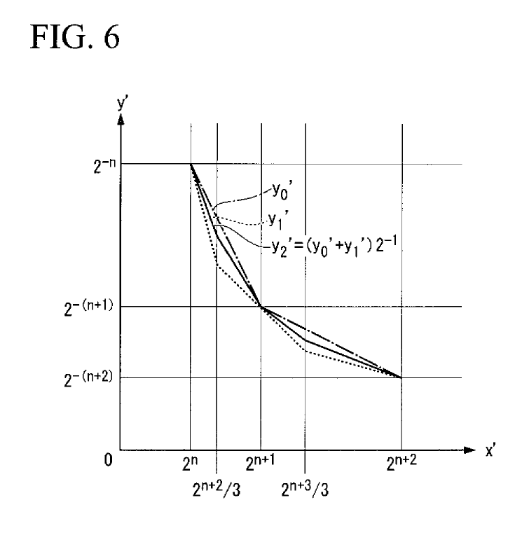

Furthermore, as shown in FIG. 4, y₀′ always indicates a value equal to or more than y′. As shown in FIG. 5, y₁′ always indicates a value equal to or less than y′. Therefore, a line y₂′, which is the average of y₀′ and y₁′ (refer to FIG. 6), is a line that approximates the curve of y′ with higher accuracy than y₀′ and y₁′. This y₂′ is expressed by the following formula.
y₂′=(y₀′+y₁′)2⁻¹

In the range of 2ⁿ≦x′<(2ⁿ⁺²3⁻¹), y₂′ is expressed by the following formula.
y₂′={(−x′+3×2ⁿ)(2²ⁿ⁺¹)⁻¹+(−x′+2ⁿ⁺¹)(2ⁿ)⁻²}2⁻¹=(−3x′+7×2ⁿ)(2ⁿ⁺¹))⁻²

On the other hand, in the range of (2ⁿ⁺²3⁻¹)≦x′<2ⁿ⁺¹, y₂′ is expressed by the following formula.
y₂′={(−x′+3×2ⁿ)(2²ⁿ⁺¹)⁻¹+(−x′+2ⁿ⁺²)(2ⁿ⁺¹)⁻²}2⁻¹=(−3x′+5×2ⁿ⁺¹)(2ⁿ⁺¹)⁻²

The reciprocal calculation portion 12 according to the present embodiment uses these y₂′ to calculate the reciprocal of x′.

Furthermore, in the present embodiment, with the reciprocal calculation portion 12 being modified to use y₂′ to derive the approximation formula of y′, the method for the range identification portion 11 to determine the range of x′ is also modified. In the first embodiment, y₀′ is used. Therefore, as shown in FIG. 4, the ranges are segmented at every 2ⁿ, which is a change point of y₀′. However, in the present embodiment, y₂′ is used. Therefore, as shown in FIG. 6, the ranges are segmented at every 2ⁿ and (2ⁿ⁺²3⁻¹), which are change points of y₂′.

As described above, according to the present embodiment, a reciprocal of input data can be speedily calculated without the use of a memory that stores the gradient data values and intercept data values necessary for deriving an approximation formula of the inverse proportional curve, as is the case with the first embodiment. Furthermore, by calculating a reciprocal of input data from an averaging resultant approximation formula of two approximation formulas that approximate the inverse proportional curve, it is possible to obtain a calculation result with higher accuracy than that of the first embodiment.

While embodiments of the present invention have been described in detail with reference to the drawings, these are not to be considered as limitative in terms of specific configurations. The present invention includes design modifications and the like in the range that does not depart from the spirit or scope of the invention. For example, a program for implementing the operations and functions of the above embodiments may be stored in a computer-readable medium, and a computer may be allowed to read and execute the program stored in this recording medium.

Here, a “computer” includes a home page providing environment (or display environment) in the case where a WWW system is utilized. Moreover, a “computer-readable medium” refers to a portable medium such as a flexible disk, optical magnetic disk, ROM, and CD-ROM as well as a storage device such as a hard disk built into a computer. Furthermore, a “computer-readable medium” includes any medium that temporarily holds a program such as a volatile memory (RAM) inside a computer system which functions as a server or a client when the program is sent via a network such as the Internet or via a communication line such as a telephone line.

Moreover, the above program may be transmitted from a computer that has this program stored in a storage device to another computer via a transmission medium or by transmission waves in a transmission medium. Here, the “transmission medium” that transmits the program refers to any medium with a function of transmitting information, which includes a network (a communication network) such as the Internet as well as a communication line (a communication wire) such as a telephone line. Furthermore, the above program may be any program for implementing a part of the above-described functions. Moreover, it may be any program that can be implemented in combination with a program already stored in a computer, that is, a so-called differential file (a differential program).

According to the present invention, the coefficient of the linear approximation formula that approximates the inverse proportional curve is calculated with one boundary value of the range to which the intermediate data belongs and another boundary value thereof as variables, the boundary values being represented by factorials of 2. Therefore, it is possible to calculate a reciprocal of input data without the use of a memory that stores the gradient data and interceptor data of the approximation formulas of the inverse proportional curve.

The present invention is not limited by the above-mentioned descriptions, but is limited only by the scope of the appended claims.

What is claimed is:

1. A reciprocal calculation unit comprising:
a data transformation portion that through a first bit shift operation on input data, transforms the input data to intermediate data that falls in a predetermined data extent;
a range identification portion that identifies a range to which the intermediate data belongs out of ranges that are established within the data extent and have boundary values defined by values of factorials of 2;
a reciprocal calculation portion that calculates a coefficient of a linear approximation formula of an inverse proportional curve with the intermediate data as variables based on one boundary value and another boundary value of the range to which the intermediate data belongs, and calculates a reciprocal of the intermediate value from the calculated coefficient and the intermediate data; and
a data re-transformation portion that through a second bit shift operation corresponding to the first bit shift operation, transforms the reciprocal of the intermediate data to a reciprocal of the input data.

2. The reciprocal calculation unit according to claim 1, wherein
the reciprocal calculation portion calculates the coefficient assuming that the linear approximation formula is a line that passes through points on the inverse proportional curve that respectively correspond to the one boundary value and the another boundary value.

3. The reciprocal calculation unit according to claim 1, wherein
the reciprocal calculation portion calculates the coefficient assuming that the linear approximation formula is formed by linking tangent lines at points on the inverse proportional curve that respectively correspond to the one boundary value and the another boundary value.

4. The reciprocal calculation unit according to claim 1, wherein
the reciprocal calculation portion calculates the coefficient by averaging a first coefficient assuming that the linear approximation formula is a line that passes through points on the inverse proportional curve that respectively correspond to the one boundary value and the another boundary value and a second coefficient assuming that the linear approximation formula is formed by linking tangent lines at points on the inverse proportional curve that respectively correspond to the one boundary value and the another boundary value.

5. A reciprocal calculation method that performs the steps comprising:
a data transformation step that through a first bit shift operation on input data, transforms the input data to intermediate data that falls in a predetermined data extent;
a range identification step that identifies a range to which the intermediate data belongs out of ranges that are established within the data extent and have boundary values defined by values of factorials of 2;
a reciprocal calculation step that calculates a coefficient of a linear approximation formula of an inverse proportional curve with the intermediate data as variables based on one boundary value and another boundary value of the range to which the intermediate data belongs, and calculates a reciprocal of the intermediate value from the calculated coefficient and the intermediate data; and
a data re-transformation step that through a second bit shift operation corresponding to the first bit shift operation, transforms the reciprocal of the intermediate data to a reciprocal of the input data.

6. The reciprocal calculation method according to claim 5, wherein
the reciprocal calculation step calculates the coefficient assuming that the linear approximation formula is a line that passes through points on the inverse proportional curve that respectively correspond to the one boundary value and the another boundary value.

7. The reciprocal calculation method according to claim 5, wherein
the reciprocal calculation step calculates the coefficient assuming that the linear approximation formula is formed by linking tangent lines at points on the inverse proportional curve that respectively correspond to the one boundary value and the another boundary value.

8. The reciprocal calculation method according to claim 5, wherein
the reciprocal calculation step calculates the coefficient by averaging a first coefficient assuming that the linear approximation formula is a line that passes through points on the inverse proportional curve that respectively correspond to the one boundary value and the another boundary value and a second coefficient assuming that the linear approximation formula is formed by linking tangent lines at points on the inverse proportional curve that respectively correspond to the one boundary value and the another boundary value.
